(19) United States
(12) Patent Application Publication
(10) Pub. No.: US 2026/0208728 A1
(43) Pub. Date: Jul. 23, 2026

(54) ENVIRONMENT RECOGNITION DEVICE, TRAVELABLE-AREA DETERMINATION METHOD, AND ELECTRONIC CONTROL DEVICE

(71) Applicant: Astemo, Ltd., Chiyoda-ku, Tokyo (JP)

(72) Inventors: Kento KAGIMOTO, Hitachinaka-shi, Ibaraki (JP); Shigenori HAYASE, Hitachinaka-shi, Ibaraki (JP); Tatsuhiko MONJI, Hitachinaka-shi, Ibaraki (JP)

(73) Assignee: Astemo, Ltd., Chiyoda-ku, Tokyo (JP)

(21) Appl. No.: 19/142,436

(22) PCT Filed: Jan. 17, 2023
(86) PCT No.: PCT/JP2023/001204

§ 371 Date: Jun. 23, 2025

(51) Int. Cl. B60W 30/095; B60W 30/09

(52) U.S. Cl. CPC B60W 30/0956; B60W 30/09; B60W 2552/35

(57) ABSTRACT

An environment recognition device includes an external-field information acquisition unit adapted to acquire external-field information including two-dimensional information or three-dimensional information about an object existing around a vehicle, from an external-field sensor incorporated in the vehicle, a road-surface obstacle area estimation unit adapted to recognize a road-surface obstacle existing on the traveling road surface of a traveling road on which the vehicle is travelling, based on the external-field information, and to estimate a road-surface obstacle area, an above-road-surface obstacle area estimation unit adapted to recognize an above-road-surface obstacle being apart from the traveling road surface and existing above the road surface, based on the external-field information, and to estimate an above-road-surface obstacle area, a travelable-area determination unit adapted to determine a travelable area where the vehicle can travel, based on the road-surface obstacle area and the above-road-surface obstacle area, and an output unit adapted to output information about the travelable area to a vehicle control device adapted to control a behavior of the vehicle.

### TECHNICAL FIELD

The present invention relates to an environment recognition device, a travelable-area determination method, and an electronic control device.

### BACKGROUND ART

In recent years, in order to realize comfortable and safe driving assistance and automatic driving for vehicles, there have been developed techniques for grasping travelling environments around own vehicles. For example, collision warning and automatic braking are performed, based on results of recognition of objects such as pedestrians and other vehicles, using sensors such as a camera, a millimeter-wave radar, an ultrasonic wave, and a light detection and ranging (LIDAR). Further, lane deviation warning and lane keeping are realized, by reading compartment lines and road markings painted on road surfaces, contents of travelling restrictions specified on road signs and the like.

As one of such safety functions, there is a need for a travelable-area recognition technique for expressing, as a travelable area, an area other than a region that hinders traveling of an own vehicle, within a traveling road surface. By using this travelable-area information, it is possible to perform risk calculation for safely avoiding obstacles around the own vehicle, which makes it possible to generate a safe trajectory, thereby taking avoidance actions. The travelable-area information is basically generated in consideration of obstacles in contact with the travelling road surface on which the own vehicle is travelling. However, it has been necessary to generate the travelable area information also in consideration of obstacles existing above the road surface. In this regard, techniques described in the following PTLs 1 and 2 have been proposed.

PTL 1 describes that “a vehicle control system includes: a detection unit adapted to detect an obstacle existing in a space around a vehicle and being apart from a road surface; and an action-plan generation unit adapted to estimate at least one of a size and a type of the obstacle detected by the detection unit, to predict a behavior of the obstacle based on the result of the estimation of at least one of the size and the type of the obstacle, and to generate a danger avoidance action plan for the vehicle based on the result of the prediction of the behavior of the obstacle”.

PTL 2 describes that “an autonomous travelling device includes: an information acquisition unit adapted to acquire surrounding information including distance information; a region setting unit adapted to set a road-surface region and a travelling-path space region based on the surrounding information acquired from the information acquisition unit; a road-surface-region determination unit adapted to determine whether travelling on a road surface is possible based on the surrounding information about the road-surface region set region setting unit; an obstacle determination unit adapted to determine an obstacle on a route path based on the surrounding information about the travelling-path space region; and a traveling propriety determination unit adapted to determine propriety of traveling based on the results of the determinations by the road-surface-region determination unit and the obstacle determination unit”.

### CITATION LIST

### Patent Literature

PTL 1: JP 2018-167699 A

PTL 2: JP 2016-201019 A

### SUMMARY OF INVENTION

### Technical Problem

In order to cause an own vehicle to travel safely, it is important to correctly determine the risk regarding an obstacle existing on a traveling road surface. For example, even when the own vehicle has activated autonomous emergency steering (AES), if there is an obstacle, the own vehicle is required to safely travel or stop.

The technique described in PTL 1 necessitates directly avoiding the behavior of the obstacle existing apart from a road surface. However, in order to take a safe avoidance action, risk calculation is necessary. Further, in order to perform the risk calculation, it is necessary to generate a travelable area. Further, the technique described in PTL 2 detects an object in the travelling-path space region and determines it as an obstacle, but necessitates determination as to whether the own vehicle can pass under the obstacle.

The present invention has been made in view of the aforementioned circumstances, and aims at controlling a behavior of an own vehicle by determining whether the own vehicle can travel under an above-road-surface obstacle existing apart from a road surface.

### Solution to Problem

An environment recognition device according to the present invention includes: an external-field information acquisition unit adapted to acquire external-field information including two-dimensional information or three-dimensional information about an object existing around a vehicle, from an external-field sensor incorporated in the vehicle; a road-surface obstacle area estimation unit adapted to recognize a road-surface obstacle existing on a traveling road surface of a traveling road on which the vehicle is travelling, based on the external-field information, and to estimate a road-surface obstacle area; an above-road-surface obstacle area estimation unit adapted to recognize an above-road-surface obstacle being apart from the traveling road surface and existing above a road surface, based on the external-field information, and to estimate an above-road-surface obstacle area; a travelable-area determination unit adapted to determine a travelable area where the vehicle can travel, based on the road-surface obstacle area and the above-road-surface obstacle area; and an output unit adapted to output information about the travelable area to a vehicle control device adapted to control a behavior of the vehicle.

### Advantageous Effects of Invention

According to the present invention, an above-road-surface obstacle existing apart from a road surface is recognized, a travelable area where a vehicle can travel is determined, and the behavior of the own vehicle is controlled, which can prevent the own vehicle from erroneously entering an entry-prohibited area with height restriction, for example.

### BRIEF DESCRIPTION OF DRAWINGS

FIG. 1 is a structural diagram illustrating the connection relationship between an environment recognition device according to a first embodiment of the present invention, and other devices.

FIG. 2 is a block diagram illustrating an example of the internal structures of a vehicle sensor, an external-field sensor, and a map-information provision device according to the first embodiment of the present invention.

FIG. 3 is an explanatory diagram of functions of a GNSS and a locator according to the first embodiment of the present invention.

FIG. 4 is a block diagram illustrating an example of the internal structure of the environment recognition device according to the first embodiment.

FIG. 5 is a flowchart illustrating a procedure for generating a travelable area according to the first embodiment of the present invention.

FIG. 6A is a view illustrating an example of a travelling environment around an own vehicle according to the first embodiment of the present invention.

FIG. 6B is a view illustrating an example of an initial travelable area acquired by an external-field information acquisition unit according to the first embodiment of the present invention.

FIG. 6C is a view illustrating an example of a road-surface obstacle area set on a traveling road according to the first embodiment of the present invention. FIG. 6D is a view illustrating an example of the initial travelable area excluding a road-surface obstacle area according to the first embodiment of the present invention.

FIG. 7A is a view illustrating an example of a contour of an own vehicle according to the first embodiment of the present invention.

FIG. 7B is a view illustrating an example of a contour of a structure according to the first embodiment of the present invention.

FIG. 8A is a view illustrating an example where the contour of the own vehicle is not coming into contact with the contour according to the first embodiment of the present invention.

FIG. 8B is a view illustrating an example where the contour of the own vehicle is coming into contact with the contour according to the first embodiment of the present invention.

FIG. 9 is a view illustrating examples of initial travelable areas detected by a plurality of sensors according to the first embodiment of the present invention. FIG. 10 is a view illustrating an example of an above-road-surface obstacle area according to the first embodiment of the present invention.

FIG. 11 is a view illustrating an example of an above-road-surface obstacle area indicating that the own vehicle can not pass therethrough according to the first embodiment of the present invention.

FIG. 12A is a view illustrating an example of a travelable area restricted only to the insides of forward lanes according to the first embodiment of the present invention.

FIG. 12B is a view illustrating an example of a travelable area including the outside of the forward lanes according to the first embodiment of the present invention.

FIG. 12C is a view illustrating an example of a travelable area during normal travelling according to the first embodiment of the present invention.

FIG. 12D is a view illustrating an example of a travelable area during emergency travelling according to the first embodiment of the present invention.

FIG. 13 is a block diagram illustrating an example of the hardware structure of a computing machine according to the first embodiment of the present invention.

FIG. 14 is a block diagram illustrating an example of the internal structure of an environment recognition device according to a second embodiment of the present invention.

FIG. 15 is a block diagram illustrating an example of the internal structure of an environment recognition device according to a third embodiment of the present invention.

FIG. 16 is a block diagram illustrating an example of the internal structure of an environment recognition device according to a fourth embodiment of the present invention.

### DESCRIPTION OF EMBODIMENTS

Hereinafter, embodiments of the present invention will be described with reference to the accompanying drawings. In the present specification and the drawings, components having substantially the same function or structure are denoted by the same reference character, and will not be described redundantly. The present invention is applicable to, for example, an arithmetic device for vehicle control with which an advanced driver assistance system (ADAS) or an in-vehicle electronic control unit (ECU) for autonomous driving (AD) can communicate.

### First Embodiment

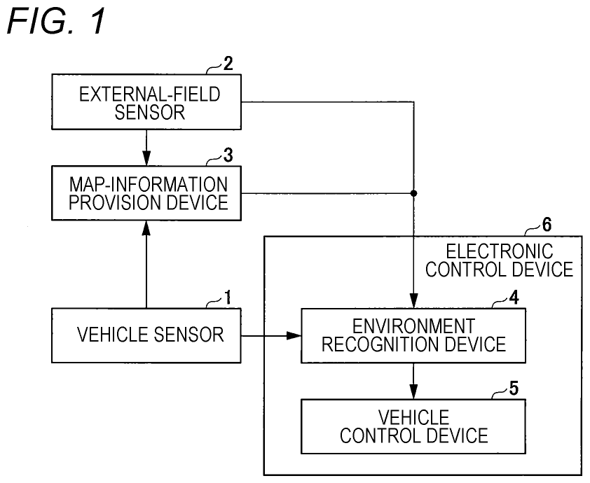

FIG. 1 is a structural diagram illustrating the connection relationship between an environment recognition device 4 according to the first embodiment of the present invention, and other devices.

A vehicle sensor 1, an external-field sensor 2, a map-information provision device 3, and a vehicle control device 5 are connected to the environment recognition device 4. An electronic control device (Electronic Control Unit: ECU) 6 includes the environment recognition device 4 and the vehicle control device 5. The vehicle sensor 1, the external-field sensor 2, the map-information provision device 3, the environment recognition device 4, the vehicle control device 5, and the electronic control device 6 are examples of devices and sensors incorporated in the same automobile. An automobile incorporating these devices and sensors is referred to as an “own vehicle”.

The vehicle sensor 1 detects states of the own vehicle and outputs own-vehicle information indicating states of the own vehicle to the map-information provision device 3 and the environment recognition device 4.

The external-field sensor 2 detects an environment around the own vehicle and outputs environment information indicating the environment around the own vehicle to the map-information provision device 3 and the environment recognition device 4.

The map-information provision device 3 generates map information based on the own-vehicle information and the environment information, and provides the map information to the environment recognition device 4.

The environment recognition device 4 acquires the vehicle information about the own vehicle from the vehicle sensor 1, and acquires the environment information indicating the environment around the own vehicle from the external-field sensor 2. Further, the environment recognition device 4 acquires the map information from the map-information provision device 3.

The environment recognition device 4 outputs, to the vehicle control device 5, environment information obtained by recognizing an environment around the own vehicle, based on the respective pieces of information acquired from the vehicle sensor 1, the external-field sensor 2, and the environment recognition device 4.

The vehicle control device 5 controls the operation of the own vehicle, based on the environment information. At this time, the vehicle control device 5 executes an action plan and vehicle control for the own vehicle, such that the own vehicle travels in a free space. According to the present embodiment, the vehicle control device 5 generates a travelable area for the own vehicle, based on information about a free space. Further, the vehicle control device 5 performs the action plan and the operation control for the own vehicle, such that the own vehicle travels in the travelable area.

Here, the free space is an area around the own vehicle where the own vehicle can travel and which excludes target objects such as pedestrians,, other vehicles, pylons, and falling objects, for example. Furthermore, it is necessary to utilize such a free space, in emergency steering for escaping from a roadside zone to a curbstone region, and the like. Further, by determining a trajectory set for the action plan for the own vehicle in the free space, it is possible to generate a safe trajectory, which enables the own vehicle to travel safely. For example, in a case where a pylon is installed on a road being under construction, a preceding vehicle is highly likely to decelerate and, therefore, the vehicle control device 5 performs an action plan such that the own vehicle can also safely decelerate. Further, in a case where the preceding vehicle is stopped, the vehicle control device 5 performs an action plan such that the own vehicle can urgently avoid the preceding vehicle.

The electronic control device 6 is a device provided, for example, in a case where the environment recognition device 4 and the vehicle control device 5 are integrated as a zone ECU. Therefore, in a case where the environment recognition device 4 and the vehicle control device 5 are not integrated, the electronic control device 6 may have functions different from those of the environment recognition device 4 and the vehicle control device 5.

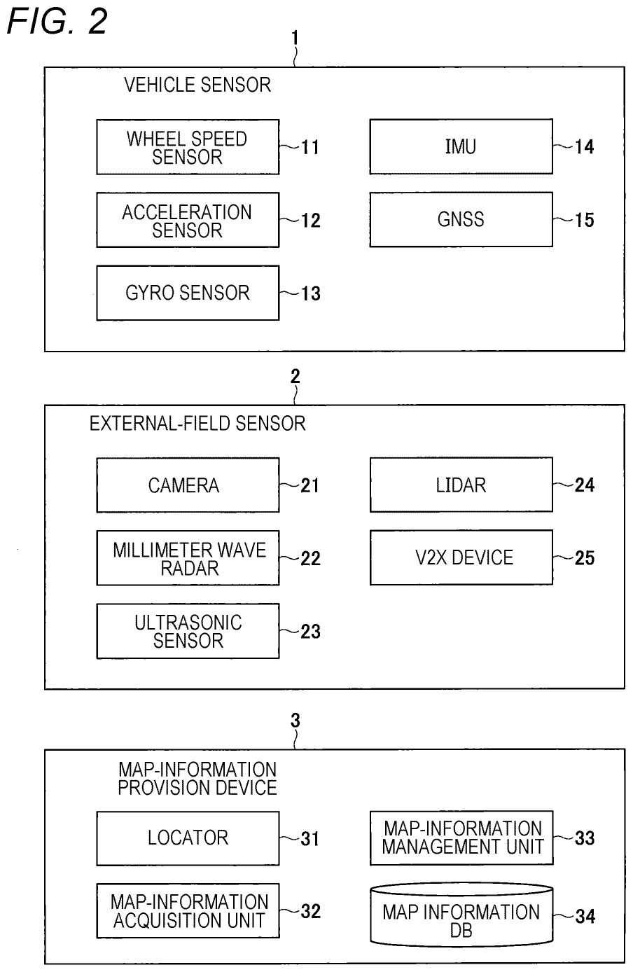

FIG. 2 is a block diagram illustrating an example of the internal structures of the vehicle sensor 1, the external-field sensor 2, and the map-information provision device 3.

### Vehicle Sensor

The vehicle sensor 1, which is a group of sensors for detecting states of the own vehicle, measures a vehicle speed, an acceleration, an angular speed, position information such as a latitude, a longitude, and an azimuth of the own vehicle, and other information. The vehicle sensor 1 includes, for example, a wheel speed sensor 11, an acceleration sensor 12, a gyro sensor 13, an inertial measurement unit (IMU) 14, and a global navigation satellite system (GNSS) 15.

The wheel speed sensor 11 detects a vehicle speed, based on a rotating speed of a tire of the own vehicle.

The acceleration sensor 12 detects an acceleration of the own vehicle.

The gyro sensor 13 detects an angular speed of the own vehicle.

The IMU14 is an inertial sensor and detects an inertia of the own vehicle.

The GNSS15 acquires a position (latitude/longitude) and an azimuth of the own vehicle on the ground. The operation of the GNSS15 will be described later, in detail.

### External-Field Sensor

The external-field sensor 2, which is a group of sensors for detecting an environment around the own vehicle, measures the positions, heights, types, and the like of surrounding objects, compartment lines, road markings, and the like around the own vehicle, positional relationships between other vehicles and the own vehicle, and the like. The external-field sensor 2 includes, for example, a camera 21, a millimeter wave radar 22, an ultrasonic sensor 23, a light detection and ranging (LIDAR) 24, and a vehicle-to-everything (V2X) device 25. V2X is a designation of transmitting information between a vehicle and other devices through connection therebetween.

The camera 21 captures an image of an environment around the own vehicle. The camera 21 may be either a monocular camera, a stereo camera, or a multi-camera for capturing images of surroundings of the own vehicle, for example.

The millimeter wave radar 22 irradiates a target object with a millimeter wave in the frequency range from 30 GHz to 300 GHz, and detects a distance to the target object from the own vehicle, an angle between the target object and the own vehicle, and the like.

The ultrasonic sensor 23 detects a distance to an object using ultrasonic waves.

The LIDAR24 detects a distance to an object using pulsed laser light.

The V2X device 25 connects the own vehicle and an appliance in another vehicle to each other, thereby causing them to transmit and receive information to and from each other.

### Map-Information Provision Device

The map-information provision device 3 receives inputs of an own-vehicle speed, an acceleration, and attitude information from the vehicle sensor 1, and position information about a latitude, a longitude, an azimuth and the like from the GNSS15 included in the vehicle sensor 1. The attitude information includes information about a vehicle traveling direction, and amounts of rotations of the own vehicle about respective axes, and, further, includes information about a roll angle, a pitch angle, and a yaw angle. The map-information provision device 3 includes, for example, a locator 31, a map-information acquisition unit 32, a map-information management unit 33, and a map-information database (DB) 34.

The locator 31 determines an amount of movement of the own vehicle during own-vehicle processing cycles, based on the wheel speed, the acceleration, and the attitude information acquired from the vehicle sensor 1. Further, the locator 31 estimates the position and the azimuth of the own vehicle in the map acquired by the map-information acquisition unit 32, based on the estimated amount of movement of the own vehicle. The position estimated by the locator 31 may be either a latitude and a longitude, or a position in a plane rectangular coordinate system.

The map-information acquisition unit 32 acquires map information corresponding to the position of the own vehicle, based on the latitude, the longitude, and the azimuth of the own vehicle having been acquired from the GNSS15. Further, the map-information acquisition unit 32 stores the map information in the map-information DB 34. The map information is a map including information about the positions of compartment lines painted on roads, road ends, road signs and road markings, the positions and heights of structures, and the like. The map information is referred to as a high-precision map, a high-definition map, or the like.

The map-information management unit 33 updates or deletes map information about surroundings of the own vehicle which has been stored in the map-information DB 34, based on the position of the own vehicle having been acquired from the GNSS15. For example, there is a possibility that map information has been partially changed due to constructions, modifications of structures, and the like, even though the map has been acquired once. Therefore, the map-information management unit 33 updates the contents, when new map information has been acquired.

The map-information DB 34 stores map information about surroundings of the own vehicle, and map information including information about travelling roads to a destination for the own vehicle. The map information about surroundings of the own vehicle includes, for example, information about buildings, elevated bridges, traffic signals, road signs and markings.

Further, map information about a place distant from the own vehicle by a certain distance is unnecessary, and the map-information management unit 33 deletes unnecessary map information from the map-information DB 34, in order to prevent squeeze on the storage region of the map-information DB 34. Through these processes, the map-information provision device 3 outputs information about the position of the own vehicle, and map information including information about compartment lines, road ends, road markings and road signs on travelling road surfaces on which the own vehicle is travelling, the positions and heights of structures, and the like.

### Description of the Functions of the GNSS and the Locator

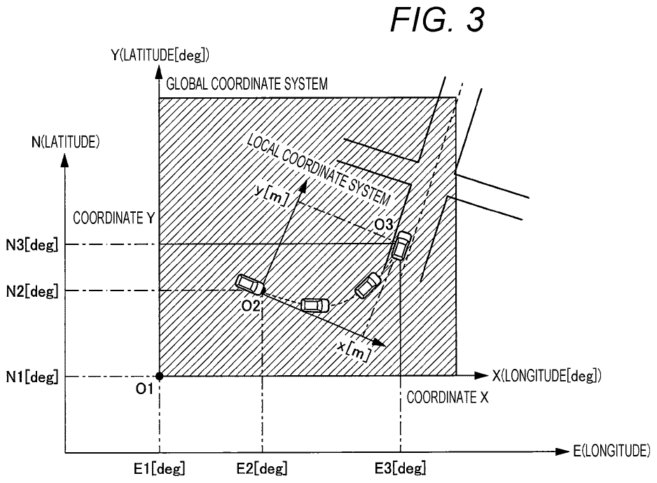

FIG. 3 is an explanatory view of the functions of the GNSS15 and the locator 31. FIG. 3 illustrates global coordinates with an origin point at a reference position in a map acquired by the map-information acquisition unit 32 based on the latitude and longitude of the own vehicle having been acquired from the GNSS15 and, further, illustrates local coordinates with respect to the own vehicle as a reference, wherein the global coordinates and the local coordinates are superimposed on each other.

The coordinates in the map acquired from the map-information acquisition unit 32 are represented by coordinates along a horizontal axis of E and a vertical axis of N. Incidentally, the unit of the horizontal axis E is the longitude [deg], and the unit of the vertical axis N is the latitude [deg]. A point O1 in the map is the coordinates of the origin point of the map, and is identified by coordinates (E1, N1). Further, the coordinates of the own vehicle at the time of activation of the own vehicle, which are acquired from the GNSS15, serve as a reference point for identifying the coordinates of the own vehicle, which will move thereafter. Therefore, the coordinates of the own vehicle at the time of activation of the own vehicle correspond to a point O2 in the figure, and are identified by coordinates (E2, N2). As the own vehicle travels, the coordinates of the own vehicle also change. As illustrated in the figure, the current coordinates of the own vehicle at the destination of turn-left of the own vehicle correspond to a point O3 in the figure and are identified by coordinates (E3, N3).

On the other hand, the global coordinates are represented as coordinates along a horizontal axis of X and a vertical axis of Y. Incidentally, the unit of the horizontal axis X is the longitude [deg], and the unit of the vertical axis Y is the latitude [deg]. The rectangular region for the global coordinates, which is indicated by hatching in the figure, represents the map acquired by the map-information acquisition unit 32, based on the position information acquired from the GNSS15 in the own vehicle. For the global coordinates, similarly, the point O1 in the figure is the reference position (namely, the origin point) in the map. Further, the current coordinates of the own vehicle at the destination of turn-left of the own vehicle correspond to the point O3 in the figure and are identified by the coordinates (E3, N3).

The local coordinates are represented by coordinates along a horizontal axis of x and a vertical axis of y. Incidentally, the unit of the horizontal axis x is [m], and the unit of the vertical axis y is [m]. Here, the locator 31 calculates the amount of movement from a certain reference position, based on the speed, the acceleration, and the attitude of the own vehicle, and the position and the azimuth acquired from the GNSS15. For example, the locator 31 calculates the amount of movement of the own vehicle during processing (controlling) cycles or the total amount of movement of the own vehicle after power-on of the own vehicle.

The locator 31 is mainly used for determining the amount of movement of the own vehicle in an environment where the GNSS15 can not acquire information. For example, the locator 31 estimates the amount [m] of movement of the own vehicle, in a situation where satellite radio waves can not reach the own vehicle, such as in a tunnel or under the ground. Also, the locator 31 estimates the amount [m] of movement of the own vehicle (with a processing cycle of about 50 ms, for example), during reception cycles (generally, 1-second cycles) of the GNSS15. Further, when associating the amount [m] of movement determined by the locator 31 with the latitude, longitude, and azimuth acquired from the GNSS15, the map-information management unit 33 converts the amount [m] of movement into an amount [deg] of movement, using the Hubeni formula or the like, and conforms it to the latitude, longitude, and azimuth of the own vehicle to determine the position (latitude and longitude) and the azimuth on the ground.

### Example of the Detailed Internal Structure of the Environment Recognition Device

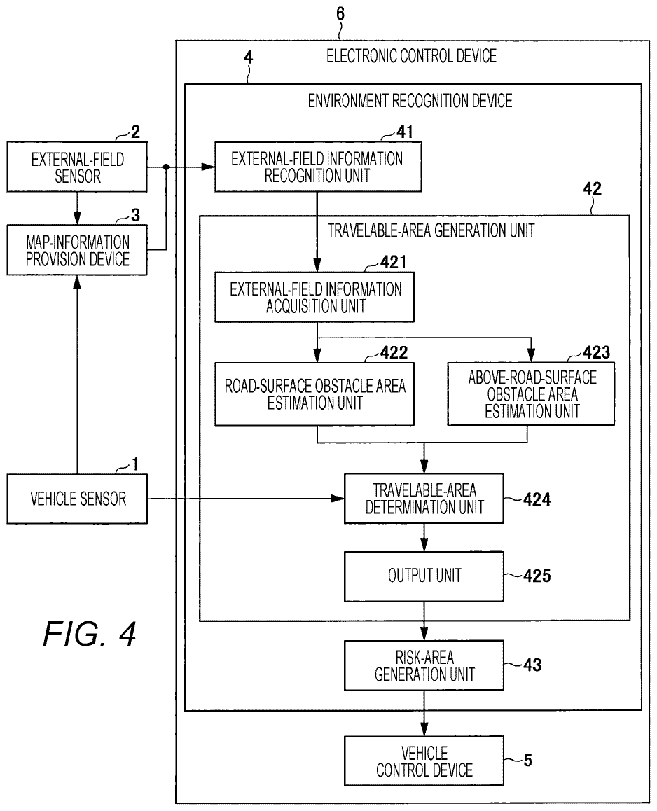

Next, an example of the detailed internal structure of the environment recognition device 4 will be described, with reference to FIG. 4.

FIG. 4 is a block diagram illustrating an example of the internal structure of the environment recognition device 4 according to the first embodiment.

The environment recognition device 4 includes an external-field information recognition unit 41, a travelable-area generation unit 42, and a risk-area generation unit 43.

The external-field information recognition unit 41, which is provided in the environment recognition device 4, acquires environment information indicating an environment around the own vehicle from the external-field sensor 2, acquires map information from the map-information provision device 3, and recognizes external-field information based on the acquired environment information and map information. As the environment information, the external-field information recognition unit 41 acquires, for example, the positions, heights, types and the like of objects around the own vehicle, compartment lines and road markings painted on road surfaces, the positions and heights of road ends, the types and the like of road ends, roadside objects such as road signs installed on the traveling road surfaces, and information about travelable areas excluding the positions of obstacles around the own vehicle, which have been detected by the external-field sensor 2. The external-field sensor 2 itself can detect a travelable area (so-called free space information). Further, the external-field information recognition unit 41 acquires a speed, an acceleration, attitude information, and the like of the own vehicle from the external-field sensor 2, as observation information.

Furthermore, the external-field information recognition unit 41 acquires, as map information, information about the position (the latitude, the longitude, and the like) and the azimuth of the own vehicle, for example, from the map-information provision device 3.

Furthermore, the external-field information recognition unit 41 has a function of semantic segmentation or the like for recognizing a collection of pixels which forms a characteristic category (people, a vehicle, a traffic sign, a road structure, or the like), in an image of surroundings of the own vehicle having been detected by the camera 21 (see FIG. 2) in the external-field sensor 2. Further, the external-field information recognition unit 41 acquires information about the position and height of the contour of a recognized object.

Furthermore, the external-field information recognition unit 41 can also integrate pieces of information regarded as the same, out of pieces of observation information that can be acquired from the plurality of sensors (the camera 21, the millimeter wave radar 22, the ultrasonic sensor 23, the LIDAR24, the V2X device 25, and the like), and can identify the position, size, and type of an object around the vehicle, based on the integrated information. Further, the external-field information recognition unit 41 can output the result of the recognition. The travelable-area generation unit 42 generates a travelable area excluding obstacles around the own vehicle. The travelable-area generation unit 42 includes an external-field information acquisition unit 421, a road-surface obstacle area estimation unit 422, an above-road-surface obstacle area estimation unit 423, a travelable-area determination unit 424, and an output unit 425.

The external-field information acquisition unit (the external-field information acquisition unit 421) acquires external-field information including two-dimensional information or three-dimensional information about an object existing around the vehicle, from the external-field sensor incorporated in the vehicle. Namely, the external-field information acquisition unit 421 acquires external-field information recognized by the external-field information recognition unit 41. As will be described later, an initial travelable area is generated from the external-field information.

The road-surface obstacle area estimation unit (the road-surface obstacle area estimation unit 422) recognizes a road-surface obstacle existing on the traveling road surface of the traveling road on which the vehicle is travelling, based on the external-field information. Further, the road-surface obstacle area estimation unit (the road-surface obstacle area estimation unit 422) estimates a road-surface obstacle area. Here, the road-surface obstacle area estimation unit (the road-surface obstacle area estimation unit 422) acquires the position of the road-surface obstacle and estimates the road-surface obstacle area. Examples of the road-surface obstacle around the own vehicle include a pylon, a falling object, a person, another vehicle, and other objects which are existing in contact with the traveling road surface around the own vehicle. Examples of the road-surface obstacle also include obstacles existing below the road surface, such as a partial depression of the road surface, and a port embankment.

The above-road-surface obstacle area estimation unit (the above-road-surface obstacle area estimation unit 423) recognizes an above-road-surface obstacle being apart from the traveling road surface and existing above the road surface, based on the external-field information, and estimates an above-road-surface obstacle area. Here, the above-road-surface obstacle area estimation unit (the above-road-surface obstacle area estimation unit 423) estimates the above-road-surface obstacle area, based on information about the position and height of the above-road-surface obstacle. Examples of the above-road-surface obstacle include a tunnel, an elevated bridge, a speed limit bar at a toll booth, branches of street trees, and other structures existing above the road surface.

The travelable-area determination unit (the travelable-area determination unit 424) determines a travelable area where the vehicle can travel, based on the road-surface obstacle area and the above-road-surface obstacle area. Here, the travelable-area determination unit (the travelable-area determination unit 424) determines, as the travelable area, an area obtained by excluding the road-surface obstacle area and the above-road-surface obstacle area from the initial travelable area detected by the external-field sensor.

Further, the travelable-area determination unit (the travelable-area determination unit 424) assigns, as a travelable area, an area which the vehicle can pass over or the vehicle can enter, in the road-surface obstacle area, based on at least one of the traveling state of the vehicle and the height information about the road-surface obstacle.

Incidentally, vehicle information acquired from the vehicle sensor 1 is also used for determining the travelable area. Further, the travelable-area determination unit (the travelable-area determination unit 424) determines, as the travelable area, an area obtained by excluding the road-surface obstacle and the above-road-surface obstacle from the initial travelable area generated from the vehicle information and the external-field information. The travelable area is a portion excluding various obstacles, and may be also expressed in such a form as to divide the traveling road surface into grids as in an occupancy grid map (OGM), and to assign a probability of existence of an obstacle to each cell. However, the travelable area according to the present embodiment is expressed as information indicating boundaries of the detected obstructive portions by lines connected to each other.

The output unit (the output unit 425) outputs information about the travelable area to the vehicle control device for controlling behaviors of the vehicle. Here, the output unit 425 outputs information about the travelable area determined by the travelable-area determination unit 424 to the risk-area generation unit 43.

The risk-area generation unit (the risk-area generation unit 43) generates, as risk areas, area information about risks indicating travelling danger degrees of surroundings of the vehicle, based on the travelable area outputted from the output unit (the output unit 425), and external-field information. Further, the risk-area generation unit (the risk-area generation unit 43) superimposes the risk areas on the travelable area. For example, the risk-area generation unit 43 generates, as risk areas, area information about risks indicating travelling danger degrees of surroundings of the own vehicle, based on the travelable area outputted from the output unit 425, and information about objects detected by the external-field sensor 2. Here, the risk-area generation unit 43 may consider the places other than the travelable area, as risk areas. In addition, as such risks, there are clearly-imaginable risks around objects around the own vehicle, risks in invisible portions at blind spots around objects, and the like, and, further, there are risks in roadside zones and opposite lanes. Therefore, the risk-area generation unit 43 may set stepwise risk values for respective risk areas. As the risk values, for example, indices such as risk 1 (traveling is possible in an emergency as in a roadside zone) and risk 2 (traveling is absolutely impossible as in an opposite lane) may be set for respective risk areas.

Further, the risk-area generation unit 43 superimposes information about the risk areas in the travelable area determined by the travelable-area determination unit 424, and then outputs the information about the travelable area to the vehicle control device 5.

The vehicle control device (the vehicle control device 5) generates a trajectory on which the vehicle is to travel, based on the travelable area. Further, the vehicle control device (the vehicle control device 5) performs trajectory following control for causing the vehicle to follow the trajectory, thereby controlling the travelling of the vehicle. Therefore, the vehicle control device 5 generates a trajectory on which the vehicle can safely travel, based on the information about the travelable area and the risk area, which has been acquired from the risk-area generation unit 43. Further, the vehicle control device 5 performs trajectory following control according to the trajectory. Therefore, the vehicle control device 5 receives inputs of a position of the own vehicle, attitude information, speed information and acceleration information about the own vehicle, a travelable area around the own vehicle, risk information, and the like, from the environment recognition device 4. Further, the vehicle control device 5 outputs a drive control signal, a braking control signal, and a steering control signal, thereby controlling traveling of the vehicle. Incidentally, the vehicle control device 5 may control traveling of the vehicle by receiving only an input of a travelable area outputted from the output unit 425, without interposition of the risk-area generation unit 43.

### Procedure for Generating the Travelable Area

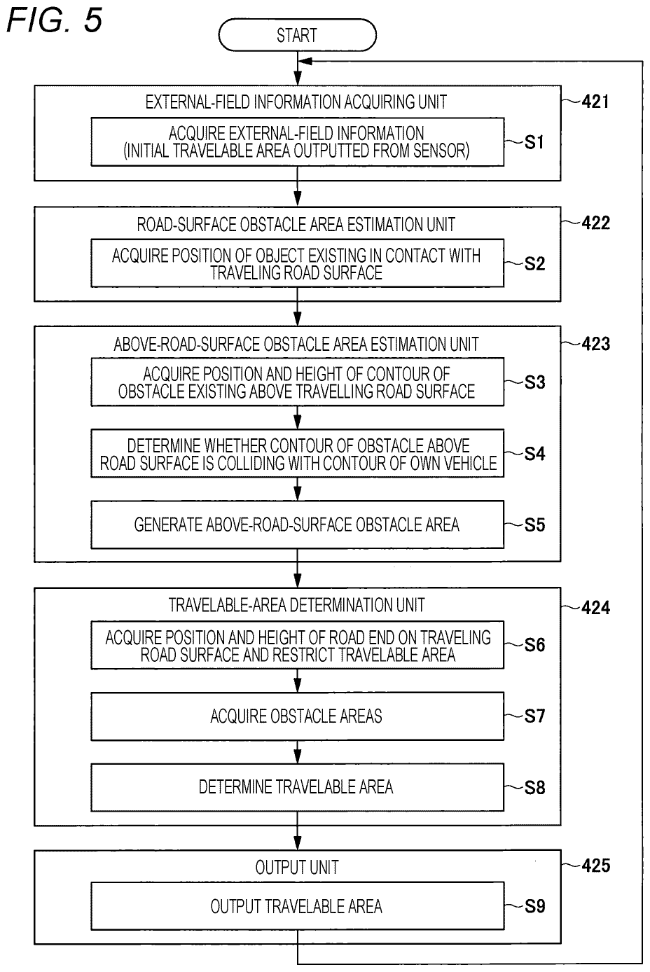

Next, there will be described an example of processing performed by the travelable-area generation unit 42 illustrated in FIG. 4, with reference to FIG. 5.

FIG. 5 is a flowchart illustrating the procedure for generating a travelable area according to the first embodiment. Here, a travelable-area determination method will be described, with reference to drawings illustrating examples of generation of a travelable area.

First, the external-field information acquisition unit 421 in the travelable-area generation unit 42 acquires external-field information from the external-field information recognition unit 41 (S1). Examples of the external-field information acquired by the external-field information acquisition unit 421 include information about objects around the own vehicle (including the positions of objects, the heights of objects, the types of objects, and structures above road surfaces), information about compartment lines (the positions of compartment lines, the colors of lines, the types of lines such as broken lines, and solid lines), which have been detected by the external-field sensors 2, such as the camera 21, the millimeter wave radar 22, and the LIDAR24. Other examples of the external-field information include road-end information (the positions and heights of road ends), map information (lane information about the traveling road (information about the forward direction and the backward direction of the lanes), road signs installed on the traveling path, road markings provided on the traveling road surface, and the positions of constructions or traffic-restricted zones), and an initial travelable area outputted from the external-field sensor 2. When the external-field information acquisition unit 421 can not acquire external-field information from the external-field sensor 2, it is possible to use compartment-line information and road-end information included in map information provided from the map-information provision device 3.

Here, there will be described a scenario representing how the vehicle travels. In the following description, an automobile incorporating the environment recognition device 4 will be referred to as an “own vehicle E”.

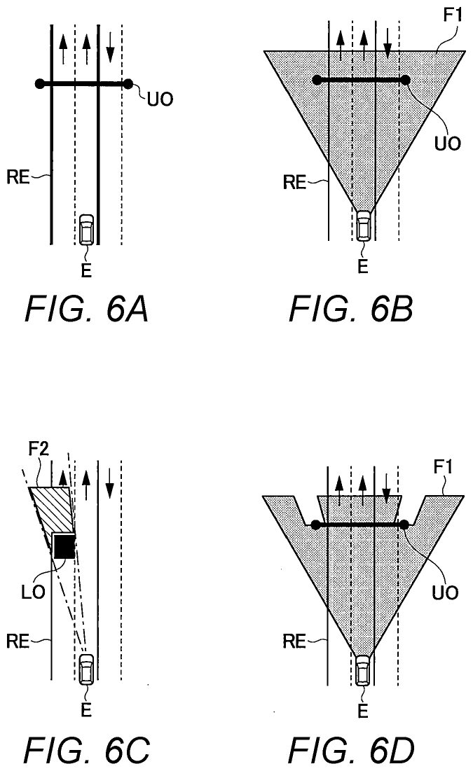

FIG. 6A is a view illustrating an example of an environment in which the own vehicle E travels.

There is a road end RE (Road End) on the left side of the road on which the own vehicle E travels (which will be referred to as a “traveling road”, hereinafter). In the road having three lanes, two lanes on the left side are forward lanes, and the rightmost lane is an opposite lane. There is also a road end RE on the right side of the road on which the own vehicle E travels, but the road end RE is not illustrated. Further, there is installed a structure UO (Upper object) straddling the forward lanes and the opposite lane, above the traveling road. As an example of the structure UO, the structure is assumed to be such a height limiting gate that the height of the structure is less than the vehicle height of the own vehicle E. Here, it is assumed that the travelling scenario specifies that the own vehicle E travels toward the structure UO installed above the travelling road. Structures UO existing above the traveling road surface according to the present embodiment include not only structures having a height restriction, such as a tunnel and an elevated bridge, but also a structure having a gate adapted to move upward and downward, and columns for supporting the gate, which are installed on the traveling road surface.

Next, there will be described an initial travelable area F1 acquired by the external-field information acquisition unit 421.

FIG. 6B is a view illustrating an example of the initial travelable area F1 acquired by the external-field information acquisition unit 421.

The initial travelable area F1 is information recognized by the external-field information recognition unit 41, through the external-field sensor 2. As the initial travelable area F1, it is possible to integrate travelable areas detected by a plurality of sensors into one travelable area, or it is possible to use a travelable area detected by a single sensor. Even if the structure UO is an elevated bridge or gate bar having such a height that the own vehicle E can not pass thereunder, the external-field sensor 2 recognizes this area as an initial travelable area F1.

Next, the road-surface obstacle area estimation unit 422 acquires the position of an object LO (Lower object) existing in contact with the traveling road surface (S2 in FIG. 5) and sets a road-surface obstacle area F2. Here, the road-surface obstacle area F2 will be described with reference to FIG. 6C.

FIG. 6C is a view illustrating an example of the road-surface obstacle area F2 set on the traveling road. It is assumed that the object LO exists on the traveling road.

The road-surface obstacle area F2 is generated, in order to enable the travelable-area generation unit 42 to generate a travelable area in a later process, when the external-field sensor 2 has not detected an initial travelable area F1. The road-surface obstacle area estimation unit 422 generates, as the road-surface obstacle area F2, a portion at a blind spot behind an object as viewed from the own vehicle E, such as a blind spot portion around the object LO, for example.

FIG. 6D is a view illustrating an example of the initial travelable area F1 excluding the road-surface obstacle area F2.

In general, the sensors do not detect an object above the road surface and, therefore, the sensors output an area excluding the portion of an object in contact with the road surface, as the initial travelable area F1. Therefore, the sensors for detecting the travelable area detects, as an obstacle, only the supporting column portions (the left and right circular-shaped end portions) of the structure UO. On the other hand, there is a vacant space under the center portion of the structure UO. Therefore, the sensors for detecting the travelable area also output, as the initial travelable area F1, an area behind the structure UO as viewed from the own vehicle, which is a portion excluding the supporting column portions of the structure UO.

However, above the traveling road surface, there exists an elevated bridge or gate bar having such a height that the own vehicle E can not pass thereunder, as described above. For coping therewith, the above-road-surface obstacle area estimation unit 423 according to the present embodiment estimates an above-road-surface obstacle area. For coping therewith, the above-road-surface obstacle area estimation unit 423 determines whether the own vehicle can pass under the structure UO, regarding the structure UO existing above the road surface, rather than the road surface obstacle regarding the object LO in contact with the traveling road surface, which has been estimated by the road-surface obstacle area estimation unit 422. Further, the above-road-surface obstacle area estimation unit 423 determines whether an above-road-surface obstacle area should be generated.

The description returns to FIG. 5.

The above-road-surface obstacle area estimation unit 423 necessitates information about the position and height of the structure UO, in order to determine whether or not an above-road-surface obstacle area should be generated. Therefore, the above-road-surface obstacle area estimation unit 423 acquires the position and height of the contour portion of the structure UO existing above the road surface (S3). Incidentally, according to a second embodiment which will be described later, information about the type of the structure UO is also acquired, in addition to information about the position and height of the contour portion of the structure UO.

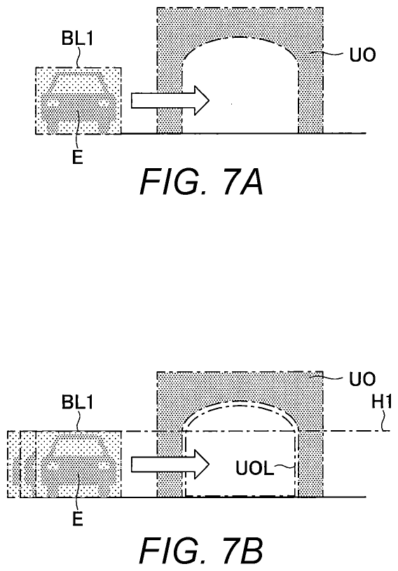

Further, the above-road-surface obstacle area estimation unit 423 defines a portion surrounded by the road surface and the inner contour of the structure UO, out of the contour of the structure UO, as a contour UOL (Upper Object Line). On the other hand, the above-road-surface obstacle area estimation unit 423 generates a contour BL (Base Line) 1 (see FIGS. 7A and 7B), when the own vehicle E is viewed at its front side. The contour BLI of the own vehicle E and the contour UOL of the structure UO will be described with reference to FIGS. 7A and 7B.

FIG. 7A is a view illustrating an example of the contour BL1 of the own vehicle E.

The contour BL1 is set in agreement with the width and the height H1 of the own vehicle E. Since the width and the height H1 of the own vehicle E are values prescribed for the corresponding vehicle type, the above-road-surface obstacle area estimation unit 423 can preliminarily acquire the width and the height H1 of the own vehicle E. However, in a case where the own vehicle E is a truck having a load platform, the height H1 of the own vehicle E may be larger than a prescribed value depending on the height of the object loaded on the load platform. Also, the own vehicle E may sink due to the weight of the object loaded on the load platform, which may decrease the height H1. Also, when the own vehicle E has a vehicle-height adjustment function, it is assumed that the height H1 varies depending on the use situation of the own vehicle E.

For coping therewith, the height H1 of the own vehicle E may be set in the environment recognition device 4, according to the state of setting of the vehicle-height adjustment function of the own vehicle E. Alternatively, the driver of the own vehicle E may capture an image of the own vehicle E with a camera incorporated in a mobile terminal, before getting in the own vehicle E, and may transfer the captured image to the environment recognition device 4. The above-road-surface obstacle area estimation unit 423 in the environment recognition device 4 can set the height H1 of the own vehicle E, based on the image transmitted from the camera in the mobile terminal. Alternatively, the driver of the own vehicle E may preliminarily set the height H1 of the own vehicle E, by inputting the height H1 of the own vehicle E through a mobile terminal or a manipulation panel in the driver's seat. With this setting, the above-road-surface obstacle area estimation unit 423 can accurately estimate whether the height of the obstacle above the road surface and the height of the own vehicle E are interfering with each other.

FIG. 7B is a view illustrating an example of the contour UOL of the structure UO.

As described above, the above-road-surface obstacle area estimation unit 423 generates a lower-side contour UOL of the structure UO, from the contour of the structure UO. Further, the above-road-surface obstacle area estimation unit 423 determines whether the contour of the obstacle above the road surface is colliding with the contour of the own vehicle (S4 in FIG. 5). Namely, the above-road-surface obstacle area estimation unit 423 determines whether the own vehicle E can enter the inside of the structure UO, that is, the contour UOL.

In the collision determination, for example, the above-road-surface obstacle area estimation unit 423 determines whether or not the contour BL1 of the own vehicle E can be enclosed between the contour UOL and the road surface, by laterally moving the contour BL1 of the own vehicle E along the traveling road surface, with respect to the contour UOL. As a method for determining whether the contour BLI of the own vehicle E can be fallen within the inside of the structure UO, it is also possible to use other methods. When the above-road-surface obstacle area estimation unit 423 determines that the own vehicle E is colliding with the contour UOL of the structure UO, the own vehicle E can not pass under the structure UO. When the above-road-surface obstacle area estimation unit 423 determines that the own vehicle E is not colliding with the contour UOL of the structure UO, the own vehicle E can pass under the structure UO.

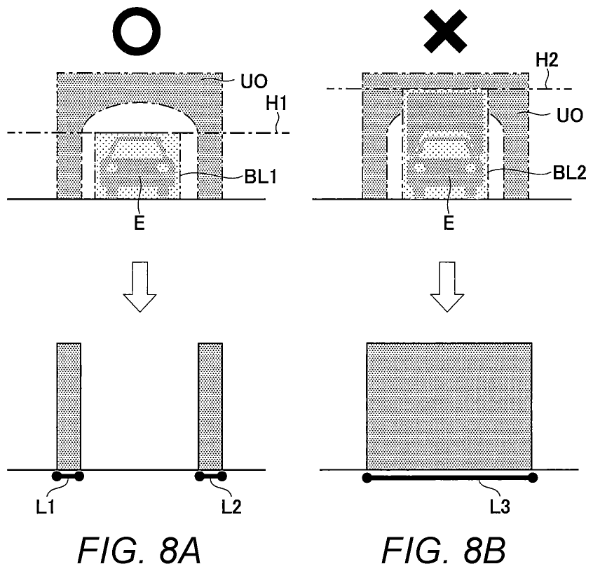

FIG. 8A is a view illustrating an example where the contour BL1 of the own vehicle E is not coming into contact with the contour UOL.

As illustrated in FIG. 8A, the vehicle height H1 of the own vehicle E is low and, therefore, the contour BL1 of the own vehicle E is not coming into contact with the contour UOL. Therefore, the above-road-surface obstacle area estimation unit 423 determines that the contour BL1 of the own vehicle E can be enclosed within the contour UOL, without coming into contact with the contour UOL. In this case, the above-road-surface obstacle area estimation unit 423 generates, as line segments L1 and L2, portions where the supporting columns of the structure UO and the road surface are in contact with each other, in the lateral direction of the traveling road surface. In an upper part of FIG. 8A, there is provided a circle mark indicating that the own vehicle E can pass under the structure UO.

FIG. 8B is a view illustrating an example where the contour BL1 of the own vehicle E is coming into contact with the contour UOL.

As illustrated in FIG. 8B, when the vehicle height H2 of the own vehicle E is larger, the contour BL1 of the own vehicle E is coming into contact with the contour UOL. Therefore, the above-road-surface obstacle area estimation unit 423 determines that the contour BL1 of the own vehicle E can not be enclosed in the contour UOL, since the contour BL1 of the own vehicle E is coming into contact with the contour UOL. In this case, the above-road-surface obstacle area estimation unit 423 encircles the outer shape of the structure UO with a polygonal shape, and generates a portion where the polygonal shape is in contact with the traveling road surface, as a line segment L3. In an upper part of FIG. 8B, there is provided a cross mark indicating that the own vehicle E can not pass under the structure UO.

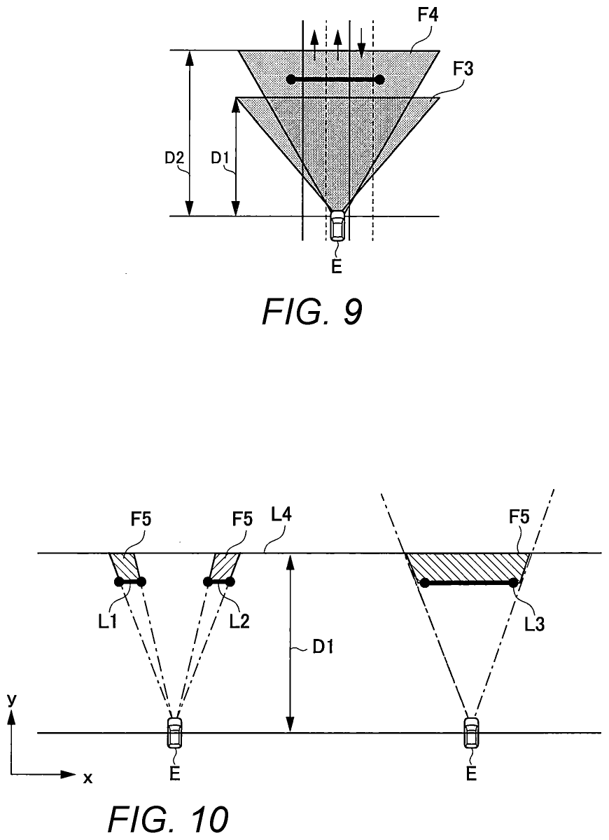

FIG. 9 is a view illustrating examples of initial travelable areas detected by the plurality of sensors.

As described with reference to FIG. 1, the external-field sensor 2 includes plural types of sensors. Regarding the travelable areas detectable by the respective sensors, the distances detectable by the respective types of sensors are different from each other. As illustrated in FIG. 9, the range of an initial travelable area F3 detectable by a certain sensor is different from the range of an initial travelable area F4 detectable by a different sensor.

The certain sensor can detect the initial travelable area F3 through a distance D1 in the depth direction, which is shorter than a distance D2 in the depth direction through which the different sensor can detect the initial travelable area F4. Therefore, in consideration of safety, the above-road-surface obstacle area estimation unit 423 adopts the distance D1 detectable by the sensor capable of detecting the travelable area with the smallest distance, out of the distances detectable by the sensors capable of detecting travelable areas, which are incorporated in the own vehicle E. Further, the above-road-surface obstacle area estimation unit 423 recognizes a portion where the initial travelable areas F3 and F4 overlap each other, as a highly-reliable area. Thus, the above-road-surface obstacle area estimation unit 423 enables using this area for generating an above-road-surface obstacle area. However, when the own vehicle E is traveling at a higher speed, it is possible to adopt the distance D2 detectable by the sensor having the longest detectable distance, out of the sensors in the own vehicle E, for detecting an obstacle above the road surface, which exists within the range of the distance D2.

FIG. 10 is a view illustrating an example of an above-road-surface obstacle area F5.

As described with reference to FIG. 8A, when the contour BL1 of the own vehicle E is not coming into contact with the contour UOL, the above-road-surface obstacle area estimation unit 423 generates blind-spot portions behind the line segments L1 and L2 as viewed from the own vehicle E, as the above-road-surface obstacle area F5. On the other hand, as described with reference to FIG. 8B, when the contour BL1 of the own vehicle E is coming into contact with the contour UOL, the above-road-surface obstacle area estimation unit 423 generates a blind-spot portion behind the line segment L3 as viewed from the own vehicle E, as the above-road-surface obstacle area F5.

For example, the above-road-surface obstacle area estimation unit 423 defines straight lines connecting the center of the own vehicle E to the both end portions of the line segments L1 and L2, and a straight line L4 at a position distant from the center of the own vehicle E by a distance D1 in the forward direction of the own vehicle in parallel to the y-axis of the own vehicle E. Further, the above-road-surface obstacle area estimation unit 423 generates areas surrounded by the respective straight lines and the line segments L1 and L2, as the above-road-surface obstacle area F5. Similarly, the above-road-surface obstacle area estimation unit 423 generates an area surrounded by straight lines connecting the center of the own vehicle E to the both end portions of the line segment L3, the defined straight line L4, and the line segment L3, as the above-road-surface obstacle area F5.

As described above, when the above-road-surface obstacle area estimation unit 423 determines that only the supporting columns of the structure UO are obstacles (see FIG. 8A), the above-road-surface obstacle area estimation unit 423 generates the above-road-surface obstacle area F5, as illustrated on the left side of FIG. 10. On the other hand, in a case where the structure UO has such a height that the own vehicle E can not pass thereunder (see FIG. 8B), the above-road-surface obstacle area estimation unit 423 generates the above-road-surface obstacle area F5 as illustrated on the right side of FIG. 10 (S5).

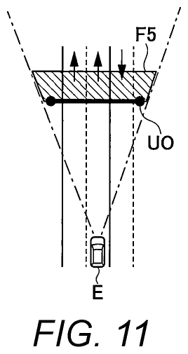

FIG. 11 illustrates an above-road-surface obstacle area through which the own vehicle E can not pass.

FIG. 11 is a view illustrating an example of an above-road-surface obstacle area F5 indicating that the own vehicle E can not pass therethrough.

When the above-road-surface obstacle area estimation unit 423 determines that the own vehicle E can not pass under the structure UO, the above-road-surface obstacle area estimation unit 423 defines the above-road-surface obstacle area F5 over the entire travelling road, as illustrated in FIG. 11. This enables the own vehicle E to stop before the structure UO.

On the other hand, even when the above-road-surface obstacle area estimation unit 423 determines that the own vehicle E can pass under the structure UO, it is unclear whether the own vehicle E can actually travel through a travelable area (an area outside the road end RE, for example) other than the above-road-surface obstacle area F5. For example, when the own vehicle E is normally travelling, it is necessary to prevent the own vehicle E from traveling outside the traveling road or in the opposite lane. For coping therewith, the travelable-area determination unit 424 performs a process for determining whether or not the own vehicle E can actually travel through the travelable area detected by the external-field sensor 2, which will be continuously described, by returning to FIG. 5.

After the step S5, the travelable-area determination unit 424 determines an area where the own vehicle E can travel. For coping therewith, the travelable-area determination unit 424 acquires a position and a height of the road end RE on the traveling road surface, using road-end information about the road end existing on the traveling road and, further, the travelable-area determination unit 424 restricts the travelable area (S6). Namely, the travelable-area determination unit 424 resets the range of the travelable area. The road-end information includes information about the position and height of the road end RE, information about the opposite lane, and the like.

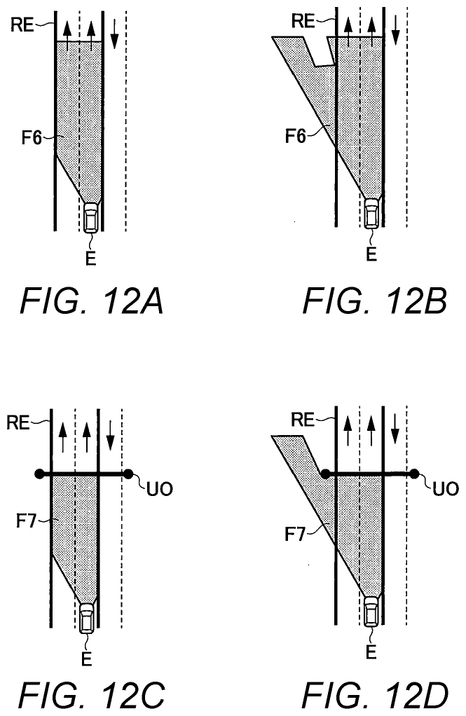

FIG. 12A is a view illustrating an example of a travelable area F6 restricted only to the insides of the forward lanes.

As illustrated in FIG. 12A, the travelable-area determination unit 424 restricts the travelable area F6 only to the forward lanes including the lane on which the own vehicle E is travelling, using the road-end information. The travelable area F6 illustrated in FIG. 12A is for normal traveling and does not include an area outside the road end RE, in order to prevent the own vehicle E from moving outside the road end RE.

FIG. 12B is a view illustrating an example of the travelable area F6 including the outside of the roadway.

It is assumed that the own vehicle E is performing emergency traveling through AES and the like, for example. At this time, the travelable-area determination unit 424 determines the travelable area F6 including the outside of the roadway, such that the own vehicle E can travel by retreating to the outside of the roadway, such as a sidewalk, only when the travelable-area determination unit 424 determines that the own vehicle E can travel safely without harming the surroundings. Examples of the outside of the roadway include a sidewalk, a road shoulder, and a refuge. The travelable area F6 is set in such a way as to prevent the own vehicle E from travelling on the opposite lane. The travelable area F6 illustrated in FIG. 12B is for emergency traveling, and includes an area outside the road end RE in order to enable the own vehicle E to retreat to the outside of the road end RE depending on the situation.

However, even when the own vehicle E is performing emergency travelling, if the road end RE has a large height, it is necessary to prevent the own vehicle E from getting out of control when getting onto the road end RE. For coping therewith, there is imposed a condition that the height of the road end RE is equal to or less than a threshold value th1. For example, the travelable-area determination unit 424 may set the height of the road end RE, by referring to the height of “an entrance portion for a vehicle” of a curbstone specified in the Road Structure Ordinance of Japan.

Next, the travelable-area determination unit 424 acquires the two types of obstacle areas generated by the road-surface obstacle area estimation unit 422 and the above-road-surface obstacle area estimation unit 423 (S7 in FIG. 5). Namely, the travelable-area determination unit 424 acquires the road-surface obstacle area F2 generated by the road-surface obstacle area estimation unit 422 and the above-road-surface obstacle area F5 generated by the above-road-surface obstacle area estimation unit 423.

Then, the travelable-area determination unit 424 corrects the travelable area detected by the external-field sensor 2, using the obstacle areas acquired from the respective estimation units. For example, the travelable-area determination unit 424 determines a final travelable area F7, by removing the obstacle areas acquired from the respective estimation units from the travelable area reset in the step S6 (S8).

FIG. 12C is a view illustrating an example of the travelable area F7 during normal travelling.

The travelable area F7 restricts traveling outside the roadway and, further, restricts travelling with the structure UO, since the own vehicle E can not pass under the structure UO. Therefore, the own vehicle E is controlled to stop in the travelable area F7.

FIG. 12D is a view illustrating an example of the travelable area F7 during emergency travelling.

The travelable area F7 restricts traveling outside the roadway and, further, restricts travelling with the structure UO, since the own vehicle E can not pass under the structure UO. The area to which the own vehicle E can retreat includes an area outside the road end RE. Therefore, the own vehicle E may be controlled to retreat to the area outside the road end RE. If the vehicle speed of the own vehicle E is high, the own vehicle E may get out of control when getting over the road end RE. Therefore, even during emergency traveling, the travelable area F7 for normal traveling illustrated in FIG. 12 C may be set, depending on the vehicle speed of the own vehicle E.

At last, the output unit 425 outputs the travelable area F7 determined by the travelable-area determination unit 424 to the risk-area generation unit 43 (S9). As described above, the risk-area generation unit 43 generates risk areas, based on the travelable area F7 and information about objects detected by the external-field sensor 2. Thereafter, the vehicle control device 5 controls traveling of the own vehicle E, based on the information about the travelable area and the risk areas. Furthermore, after the process in the output unit 425, the processing returns to the step S1, again, and the processing is executed in the loop, again. The processing is looped as described above, since it is assumed that the own vehicle travels through an ETC gate, for example. In such an ETC gate, when the gate is descended, the own vehicle E can not pass therethrough. However, when the own vehicle E has approached the ETC gate, the gate is raised, which enables the own vehicle E to pass therethrough. In such a scene that the state of an upper obstacle changes as the own vehicle E approaches it, as described above, it is necessary to perform looped processing as illustrated in FIG. 5.

### Example of the Hardware Structure of Computing Machine

Next, there will be described a hardware structure of a computing machine 50 constituting the environment recognition device 4.

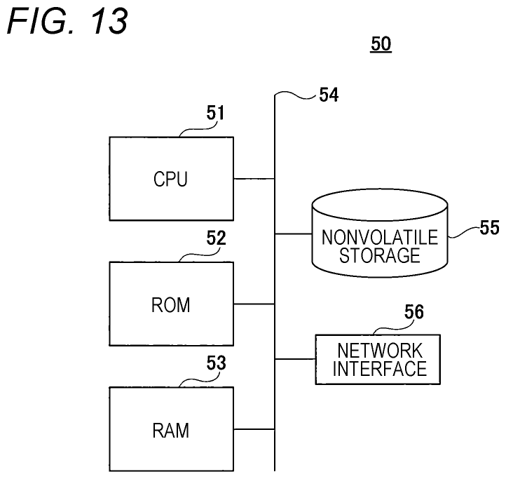

FIG. 13 is a block diagram illustrating an example of the hardware structure of the computing machine 50. The computing machine 50 is an example of hardware used as a computer operable as the environment recognition device 4 according to the present embodiment. As the environment recognition device 4 according to the present embodiment, the computing machine 50 (computer) executes a program to realize the method for determining a travelable area, which the respective functional blocks illustrated in FIG. perform in cooperation with each other.

The computing machine 50 includes a central processing unit (CPU) 51, a read only memory (ROM) 52, and a random access memory (RAM) 53, each of which is connected to a bus 54. The computing machine 50 further includes a nonvolatile storage 55 and a network interface 56.

The CPU51 reads program codes of software for realizing the respective functions according to the present embodiment from the ROM52, loads the program codes into the RAM53, and executes the program codes. Variables, parameters, and the like generated during arithmetic processing by the CPU51 are temporarily written into the RAM53, and the CPU51 reads these variables, parameters, and the like as appropriate. Incidentally, a graphics processing unit (GPU) may be used instead of the CPU51, or the CPU51 and a graphics processing unit (GPU) may be used in combination.

The nonvolatile storage 55 is constituted by, for example, a hard disk drive (HDD), a solid state drive (SSD), a flexible disk, an optical disk, a magneto-optical disk, a CD-ROM, a CD-R, a magnetic tape, a nonvolatile memory, or the like. The nonvolatile storage 55 records, therein, programs for causing the computing machine 50 to function, in addition to an operating system (OS) and various parameters. The ROM52 and the nonvolatile storage 55 record, therein, programs, data, and the like necessary for the CPU51 to operate, and are used as examples of computer-readable non-transitory storage media storing programs to be executed by the computing machine 50.

For example, the network interface 56 is constituted by, for example, a network interface card (NIC) or the like, which enables the devices to transmit and receive various types of data to and from each other via a local area network (LAN), a dedicated line, or the like connected to a terminal of the NIC.

In the environment recognition device 4 according to the first embodiment of the present invention, which has been described above, a road-surface obstacle area and an above-road-surface obstacle area are removed from a travelable area detected by the external-field sensor 2 to determine the travelable area. At this time, the travelable-area determination unit 424 can generate the travelable area, in consideration of not only structures existing in contact with the traveling road surface but also structures existing above the traveling road surface. As described above, the travelable-area generation unit 42 can generate the travelable area more realistically than conventionally, which enables the vehicle control device 5 to realize safe vehicle control such that the own vehicle can travel in the travelable area.

Furthermore, the environment recognition device 4 restricts traveling through a structure with a height restriction or in an entry-prohibited area, in consideration of the height of the own vehicle. This can prevent the own vehicle from erroneously entering an area with a height restriction or an entry-prohibited area, during travelling by autonomous driving. Further, even when the own vehicle is performing emergency traveling by activating AES, it is possible to perform steering in such a way as to avoid a structure.

Further, during normal traveling of the own vehicle E or in response to emergency traveling, it is possible to define travelable areas F7 with different ranges. This increases the possibility that the own vehicle E can safely stop or avoid a structure UO during emergency travelling.

### Second Embodiment

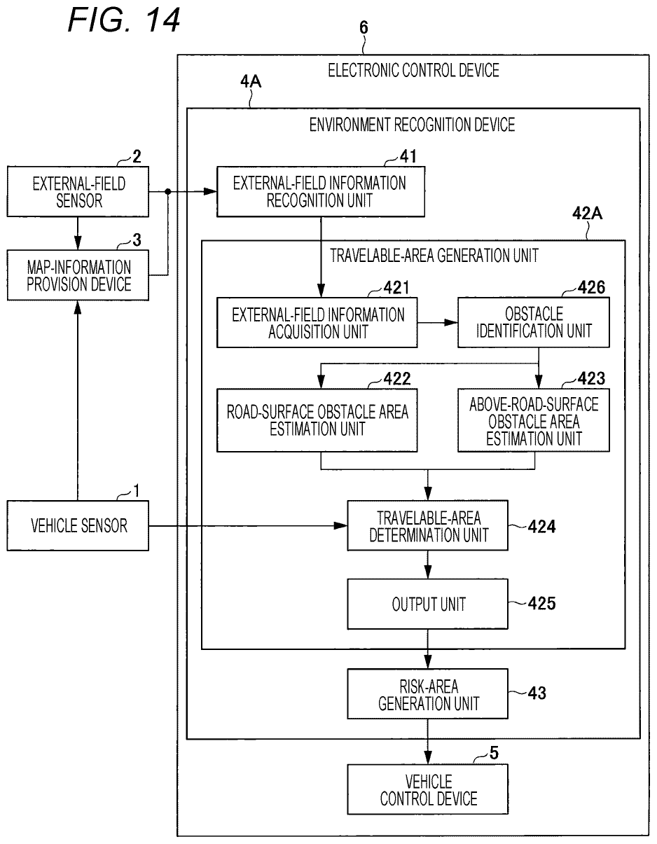

Next, there will be described an environment recognition device 4A according to a second embodiment of the present invention, with reference to FIG. 14. The environment recognition device 4A according to the second embodiment has a function of identifying the type of an obstacle.

FIG. 14 is a block diagram illustrating an example of the internal structure of the environment recognition device 4A according to the second embodiment.

The environment recognition device 4A includes an obstacle identification unit 426, in addition to the respective functional units included in the environment recognition device 4 according to the first embodiment illustrated in FIG. 4.

The obstacle identification unit (the obstacle identification unit 426) outputs the result of obstacle identification for identifying the type or the material of a portion identified as a road-surface obstacle or an above-road-surface obstacle, based on external-field information. For coping therewith, the obstacle identification unit 426 has learning data obtained by preliminarily learning about the types or materials of structures of respective types. Upon receiving the external-field information acquired by the external-field information acquisition unit 421, the obstacle identification unit 426 acquires the result of detection of an obstacle such as a structure in a travelable area, from the external-field sensors 2 (for example, the camera sensor), and identifies the type or material of the obstacle, using learning data. Examples of “type” include a curbstone and a bar in a parking lot. Examples of “material” include a concrete forming a curbstone, a rubber material covering a bar for preventing a car from being damaged even when coming into contact therewith, or the like. Further, the obstacle identification unit 426 may be adapted to acquire results of identifications of the types of various structures by the environment recognition device 4 in another vehicle, through the V2X device 25 illustrated in FIG. 2, thereby improving the accuracy of identification of the type of a similar structure when the own vehicle is travelling on a travelling road on which the similar structure exists.

Then, the obstacle identification unit 426 associates information about the identified type or material with the structure in the travelable area which has been identified by the external-field sensor 2, and outputs this information to the road-surface obstacle area estimation unit 422 and the above-road-surface obstacle area estimation unit 423.

The road-surface obstacle area estimation unit (the road-surface obstacle area estimation unit 422) estimates a road-surface obstacle area, based on the result of the obstacle identification. At this time, the road-surface obstacle area estimation unit 422 generates the road-surface obstacle area, based on the structure in the travelable area which has been identified by the external-field sensor 2, and the information about the type or material.

Further, the above-road-surface obstacle area estimation unit (the above-road-surface obstacle area estimation unit 423) estimates an above-road-surface obstacle area, based on the result of the obstacle identification. At this time, the above-road-surface obstacle area estimation unit 423 generates the above-road-surface obstacle area, based on the structure in the travelable area which has been identified by the external-field sensor 2, and the information about the type or material.

Then, the travelable-area determination unit (the travelable-area determination unit 424) assigns, as a travelable area, an area that the vehicle can pass over or the vehicle can enter, in the road-surface obstacle area, based on at least one of the traveling state of the vehicle, information about a height of the road-surface obstacle, and the result of obstacle identification. For example, even when branches of a tree protrude into the traveling road, if the above-road-surface obstacle is merely leaves or thin branches of the tree, this above-road-surface obstacle will not hinder travelling of the vehicle even in the event that the vehicle comes into contact therewith. Also, even when rainwater is falling from eaves of a building, this rainwater will not hinder traveling of the vehicle even if the vehicle comes into contact therewith. In such cases, the type of the above-road-surface obstacle is identified as “leaves” or “rainwater”, so that the travelable area is determined in such a way as to regard the above-road-surface obstacle as not hindering traveling.

In the environment recognition device 4A according to the second embodiment, which has been described above, the type or material of an obstacle such as a structure is identified and, thereafter, information about the type or material of the obstacle is outputted to the road-surface obstacle area estimation unit 422 and the above-road-surface obstacle area estimation unit 423. Therefore, the road-surface obstacle area estimation unit 422 and the above-road-surface obstacle area estimation unit 423 can appropriately estimate the road surface obstacle and the above-road-surface obstacle, based on the information about the type or material of the obstacle, to generate the road-surface obstacle area and the above-road-surface obstacle area.

### Third Embodiment

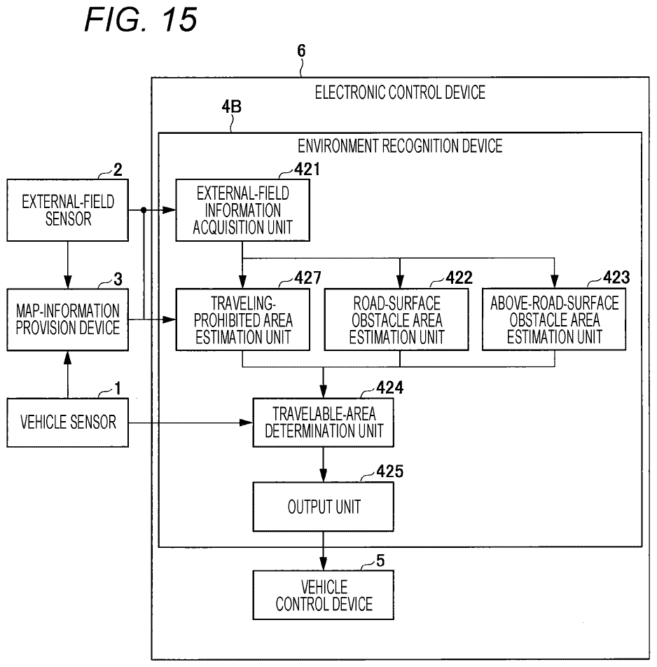

Next, there will be described an environment recognition device 4B according to a third embodiment of the present invention, with reference to FIG. 15. The environment recognition device 4B according to the third embodiment has a function of estimating a travelling-prohibited area, based on map information and the like.

FIG. 15 is a block diagram illustrating an example of the internal structure of the environment recognition device 4B according to the third embodiment.

The environment recognition device 4B includes a traveling-prohibited area estimation unit 427, in addition to the respective functional units included in the environment recognition device 4 according to the first embodiment illustrated in FIG. 4.

The traveling-prohibited area estimation unit (the traveling-prohibited area estimation unit 427) estimates a travelling-prohibited area where vehicles are prohibited from traveling, based on a sign or a marking on the travelling road on which the vehicle is travelling. For example, by acquiring map information from the map-information provision device 3, the traveling-prohibited area estimation unit 427 can estimate a travelling-prohibited area, with respect to external-field information acquired by the external-field information acquisition unit 421.

Examples of the traveling-prohibited area include an area defined by a road sign or road marking indicating that traveling is prohibited, which is specified by a law or the like. Besides, there is an area where automobiles are prohibited from travelling per hour. For example, there is an area where ordinary vehicles are prohibited from travelling, because the area serves as a traveling road dedicated for buses or a school route, in a specific time zone. In such an area where traveling is prohibited, a time zone or the like is specified on a road sign. Therefore, the traveling-prohibited area estimation unit 427 can recognize the time zone in which travelling is prohibited, based on an image of the road sign having been captured by the external-field sensor 2 (for example, the camera) . Further, the traveling-prohibited area estimation unit 427 can estimate a travelling-prohibited area in the time zone.

Further, a grade-separated crossing road such as an underpass has such a height that vehicles can travel thereon, and there is no lower obstacle thereon, in general. However, in the event of a flood of the underpass, if automobiles are not prohibited from travelling thereon, the driver of an automobile may enter the underpass without being aware of the flood. For coping therewith, the external-field information acquisition unit 421 acquires weather information, character information on an electric bulletin board installed near roads, and the like, as external-field information, and outputs these pieces of information to the traveling-prohibited area estimation unit 427. Then, the traveling-prohibited area estimation unit 427 estimates a travelling-prohibited area, based on these pieces of information.

Thereafter, the travelable-area determination unit (the travelable-area determination unit 424) determines, as a travelable area, an area obtained by excluding the travelling-prohibited area from an initial travelable area.

In the environment recognition device 4B according to the third embodiment described above, the traveling-prohibited area estimation unit 427 estimates a travelling-prohibited area. As described above, the travelling-prohibited area is an area where automobiles are prohibited from traveling, even when there is no road-surface obstacle nor above-road-surface obstacle in the area. Therefore, the travelable-area determination unit 424 can determine the travelable area in consideration of information about the travelable area. As a result, the vehicle control device 5 can safely control traveling of the automobile.

### Fourth Embodiment

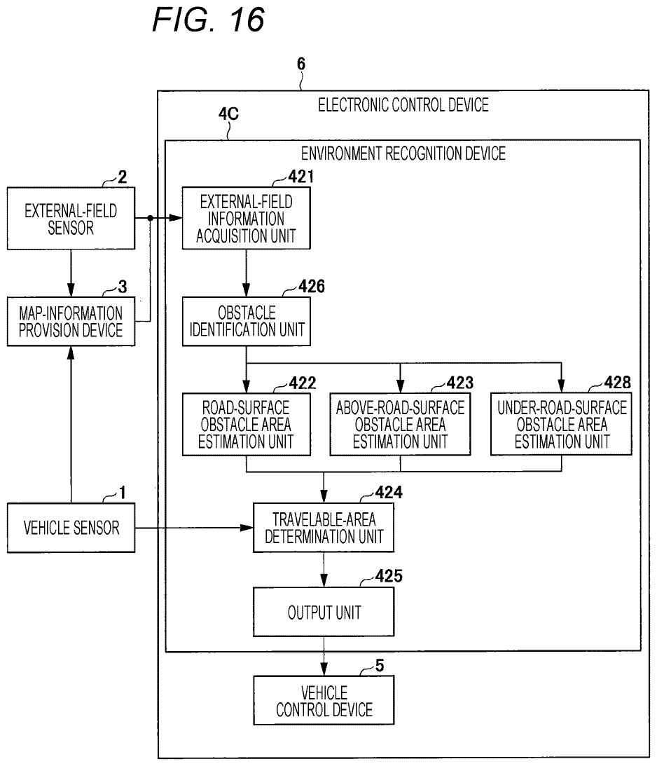

Next, there will be described an environment recognition device 4C according to a fourth embodiment of the present invention, with reference to FIG. 16. The environment recognition device 4C according to the fourth embodiment has a function of estimating a travelling-prohibited area, based on map information or the like.

FIG. 16 is a block diagram illustrating an example of the internal structure of the environment recognition device 4C according to the fourth embodiment.

The environment recognition device 4C includes all the functional units in the environment recognition devices 4, 4A and 4B according to the first to third embodiments, and, further, includes an under-road-surface obstacle area estimation unit 428. Namely, the environment recognition device 4C includes an obstacle identification unit 426, and the under-road-surface obstacle area estimation unit 428, in addition to the respective functional units included in the environment recognition device 4 according to the first embodiment illustrated in FIG. 4.

The under-road-surface obstacle area estimation unit (the under-road-surface obstacle area estimation unit 428) recognizes an under-road-surface obstacle existing under the travelling road surface and the road surface around the travelling road, based on external-field information, and estimates an under-road-surface obstacle area. For example, the under-road-surface obstacle area estimation unit 428 has a function of recognizing an object with a height less than a certain height, which is installed on the traveling road surface, as an under-road-surface obstacle. For example, when a falling object or the like having a height of 50 cm or less exists on the traveling road surface, the own vehicle needs to stop before the falling object or to travel by avoiding the falling object. For coping therewith, the under-road-surface obstacle area estimation unit 428 generates an under-road-surface obstacle area, which enables the travelable-area determination unit 424 to determine an area excluding the under-road-surface obstacle area, as a travelable area.

In the environment recognition device 4C according to the fourth embodiment described above, the under-road-surface obstacle area estimation unit 428 estimates an under-road-surface obstacle area. This causes the vehicle control device 5 to control travelling of the own vehicle, in such a way as to prevent the own vehicle from coming into contact with the road-surface obstacle. Accordingly, the vehicle control device 5 can safely control traveling of the automobile.

Incidentally, the traveling-prohibited area estimation unit 427 according to the third embodiment may be added to the environment recognition device 4C. This enables the travelable-area determination unit 424 to determine, as a travelable area, an area excluding a road-surface obstacle area, an above-road-surface obstacle area, an under-road-surface obstacle area, and a travelling-prohibited area.

Incidentally, the present invention is not limited to the aforementioned respective embodiments, and can take other various application examples and modification examples without departing from the gist of the present invention described in the claims.

For example, the aforementioned respective embodiments have been described in detail and concretely regarding the structures of devices for facilitating understanding of the present invention, and the present invention is not necessarily limited to structures including all the described structures. Further, the structure according to an embodiment described herein can be partially replaced with the structure according to another embodiment, and, also, the structure according to an embodiment can be additionally provided with the structure according to another embodiment. Further, the structure according to each embodiment can be partially provided with other additional structures, eliminated, or replaced with other structures.

Furthermore, there are illustrated only control lines and information lines considered to be necessary for the description, and not all the control lines and the information lines in the product are illustrated. It may be considered that almost all the structures are connected to each other in actual.

### REFERENCE SIGNS LIST

1 vehicle sensor
2 external-field sensor
3 map-information provision device
4, 4A to 4C environment recognition device
5 vehicle control device
6 electronic control device
41 external-field information recognition unit
42 travelable-area generation unit
43 risk-area generation unit
421 external-field information acquisition unit
422 road-surface obstacle area estimation unit
423 above-road-surface obstacle area estimation unit
424 travelable-area determination unit
425 output unit
426 obstacle identification unit
427 traveling-prohibited area estimation unit
428 under-road-surface obstacle area estimation unit

1. An environment recognition device comprising:
an external-field information acquisition unit adapted to acquire external-field information including two-dimensional information or three-dimensional information about an object existing around a vehicle, from an external-field sensor incorporated in the vehicle;
a road-surface obstacle area estimation unit adapted to recognize a road-surface obstacle existing on a traveling road surface of a traveling road on which the vehicle is travelling, based on the external-field information, and to estimate a road-surface obstacle area;
an above-road-surface obstacle area estimation unit adapted to recognize an above-road-surface obstacle being apart from the traveling road surface and existing above a road surface, based on the external-field information, and to estimate an above-road-surface obstacle area;
a travelable-area determination unit adapted to determine a travelable area where the vehicle can travel, based on the road-surface obstacle area and the above-road-surface obstacle area; and
an output unit adapted to output information about the travelable area to a vehicle control device adapted to control a behavior of the vehicle.

2. The environment recognition device according to claim 1, wherein
the road-surface obstacle area estimation unit acquires a position of the road-surface obstacle and estimates the road-surface obstacle area,
the above-road-surface obstacle area estimation unit estimates the above-road-surface obstacle area, based on information about a position and a height of the above-road-surface obstacle, and
the travelable-area determination unit determines, as the travelable area, an area obtained by excluding the road-surface obstacle area and the above-road-surface obstacle area from an initial travelable area detected by the external-field sensor.

3. The environment recognition device according to claim 2, further comprising
an obstacle identification unit adapted to output a result of obstacle identification for identifying a type or a material of a portion identified as the road-surface obstacle or the above-road-surface obstacle, based on the external-field information,
the road-surface obstacle area estimation unit estimates the road-surface obstacle area, based on the result of the obstacle identification, and
the above-road-surface obstacle area estimation unit estimates the above-road-surface obstacle area, based on the result of the obstacle identification.

4. The environment recognition device according to claim 3, wherein the travelable-area determination unit assigns, as the travelable area, an area that the vehicle can pass over or the vehicle can enter, in the road-surface obstacle area, based on at least one of the traveling state of the vehicle, information about a height of the road-surface obstacle, and the result of the obstacle identification.

5. The environment recognition device according to claim 4, further comprising a traveling-prohibited area estimation unit adapted to estimate a travelling-prohibited area where the vehicle is prohibited from travelling, based on a sign or a marking on the travelling road on which the vehicle is travelling,
wherein the travelable-area determination unit determines, as the travelable area, an area obtained by excluding the traveling-prohibited area from the initial travelable area.

6. The environment recognition device according to claim 4, further comprising an under-road-surface obstacle area estimation unit adapted to recognize an under-road-surface obstacle existing under the traveling road surface and a road surface around the travelling road and to estimate an under-road-surface obstacle area,
wherein the travelable-area determination unit determines, as the travelable area, an area obtained by excluding the under-road-surface obstacle area from the initial travelable area.

7. The environment recognition device according to claim 2, further comprising a risk-area generation unit adapted to generate, as a risk area, area information about a risk indicating a travelling danger degree of a surrounding of the vehicle, based on the travelable area outputted from the output unit, and the external-field information, and to superimpose the risk area on the travelable area.

8. A travelable-area determination method comprising the steps of:
acquiring external-field information including two-dimensional information or three-dimensional information about an object existing around a vehicle, from an external-field sensor incorporated in the vehicle;
recognizing a road-surface obstacle existing on a traveling road surface of a traveling road on which the vehicle is travelling, based on the external-field information, and estimating a road-surface obstacle area;
recognizing an above-road-surface obstacle being apart from the traveling road surface and existing above a road surface, based on the external-field information, and estimating an above-road-surface obstacle area;
determining a travelable area where the vehicle can travel, based on the road-surface obstacle area and the above-road-surface obstacle area; and
outputting information about the travelable area to a vehicle control device adapted to control a behavior of the vehicle.

9. An electronic control device comprising an environment recognition device for recognizing an environment around a vehicle, and a vehicle control device for controlling a behavior of the vehicle, the environment recognition device comprising:
an external-field information acquisition unit adapted to acquire external-field information about a surrounding of the vehicle, from an external-field sensor incorporated in the vehicle;
a road-surface obstacle area estimation unit adapted to recognize a road-surface obstacle existing on a traveling road surface of a traveling road on which the vehicle is travelling, based on the external-field information, and to estimate a road-surface obstacle area;
an above-road-surface obstacle area estimation unit adapted to recognize an above-road-surface obstacle being apart from the traveling road surface and existing above a road surface, based on the external-field information, and to estimate an above-road-surface obstacle area;
a travelable-area determination unit adapted to determine a travelable area where the vehicle can travel, based on the road-surface obstacle area and the above-road-surface obstacle area; and
an output unit adapted to output information about the travelable area to the vehicle control device;
wherein the vehicle control device generates a trajectory on which the vehicle is to travel, based on the travelable area, and performs trajectory following control for causing the vehicle to follow the trajectory, thereby controlling travelling of the vehicle.
